(19) United States
(12) Patent Application Publication
(10) Pub. No.: US 2019/0162216 A1
(43) Pub. Date: May 30, 2019

(54) POSITIVE-LOCKING CONNECTION BETWEEN A RING GEAR MADE OF PLASTIC, AND A HOUSING PART, AND GEARED MOTOR

(71) Applicant: Bühler Motor GmbH, Nürnberg (DE)

(72) Inventors: Daniel Bierl, Schnaittach (DE); Daniel Kirchgessner, Rimpar (DE); Reiner Hettych, Nürnberg (DE)

(73) Assignee: Bühler Motor GmbH, Nürnberg (DE)

(21) Appl. No.: 16/202,442

(22) Filed: Nov. 28, 2018

(30) Foreign Application Priority Data
Nov. 29, 2017 (DE) 10 2017 221 373.6

(51) Int. Cl. F16B 4/00; F16H 57/08; F16H 57/02; F16B 1/00

(52) U.S. Cl. CPC F16B 4/008; F16H 57/08; F16H 2057/02034; F16B 1/00; F16H 57/02

(57) ABSTRACT

A mechanical connection between a ring gear made of plastic, and a housing part, the mechanical connection includes a heat-shrunk tubing made of plastic, the heat-shrunk tubing positioned in a connecting region between the ring gear and the housing part to create a positive-locking and/or frictional connection between the ring gear and the housing part.

### CROSS-REFERENCE TO RELATED APPLICATIONS

The present patent application is based on, and claims priority from, German Application No. DE 10 2017 221 373.6, filed Nov. 29, 2017, which is incorporated herein by reference in its entirety.

### BACKGROUND OF THE INVENTION

### (1) Field of the Invention

The invention relates to a positive-locking connection between a ring gear, made of plastic, and a housing part.

### (2) Description of Related Art Including Information Disclosed Under 37 CFR 1.97 AND 1.98

In practice, ring gears are connected by positive-locking and/or frictional connections such as snapping systems or by welded joints to other housing parts. The snap-in means of snap connections usually already damaged due to forced demolding processes from injection-molding machines, thereby reducing the strength of the connection. Welding methods of this type, e.g., infrared, heating element, or laser welding, require a complex set of equipment, with correspondingly high operating costs. In the case of welding processes, defects (e.g., pores, voids, charring) can also arise in the plastic material, and the strength can be reduced. Finally, during welding, roundness errors of the ring gear can be generated, whereby unpleasant noise can arise.

DE 19729988 C1 discloses a positive-locking connection between a ring gear, consisting of plastic, and a housing part, wherein the ring gear is, briefly, partially stretched and relaxed again in order to join it by three detent lugs. For this purpose, the ring gear has three radial openings. The axial positive-locking fit is thus provided only at these three connection points between the detent lugs and openings. In order to not overstretch the ring gear material, only very few connecting sites must be present. The mechanical stability is thereby limited and cannot withstand higher loads. A further disadvantage consists of the openings in the ring gear, through which dirt and moisture can penetrate into the interior. In some applications, the external appearance also plays a certain role. Openings are often perceived as rather annoying and are therefore to be avoided.

### BRIEF SUMMARY OF THE INVENTION

It is therefore the aim of the invention to present a simply constructed and easily producible positive-locking connection between a ring gear, made of plastic material, and a housing part, which connection has sufficient mechanical stability and strength, as well as favorable accuracy of shape, position, and dimensions.

Since the positive-locking connection is formed by heat-shrink tubing consisting of a plastic material, a full connection between the easily-formed joining partners can be established. These can be adapted to different requirements by simple measures. The connection by means of heat-shrink tubing is more controlled, since it always rests very close to the joining partners. In this manner, and through the use of elastomer materials, effective gas- and liquid-tight connections can be created. The rubber-like elastomer material, moreover, dampens the transmission of structure-borne noise and thereby improves the acoustic properties.

A particularly important measure is a rotation lock between the ring gear and the housing part. In principle, frictional mechanical connections can be produced by heat-shrink tubing, whose strength depends upon the material parameters such as roughness and surface geometry, and the characteristic values of the heat-shrink tubing.

A particularly simple to produce mechanical connection is provided by a positive-locking fit formed by the heat-shrink tubing itself. Simple contours can hereby contribute to effective strength of the mechanical connection.

Greater mechanical strength can be achieved in that positive-locking contours are already provided in the ring gear and in the housing part, which are secured against unlocking by heat-shrink tubing. In this way, the largest part of the forces which arise is absorbed by the positive-locking contours, and the heat-shrink tubing must absorb only the reaction forces that act in the radial direction.

A development of the invention provides that the ring gear be secured in a positive-locking manner against rotation with respect to the housing part. As a result, the heat-shrink tubing has to absorb only axial forces or small radial forces, depending upon the further design of the connection.

A rotation lock can be realized in different ways. One possibility is for the parts to be connected and to be provided with interlocking teeth that absorb all the forces and distribute them over a large surface. They additionally act as a rotation lock. The teeth may be formed, on the one hand, on the ring gear and, on the other hand, on an adapter which serves as a mechanical interface between the housing part and the ring gear. The adapter is part of a transmission housing and, simultaneously, part of an engine housing.

Another possibility for achieving a rotation lock consists of providing one, two, three, four, or more axial projections in the ring gear which engages/engage in corresponding cutouts of the housing part or vice versa. Care must be taken to ensure that the projections do not reach the base of the cutouts, but that a clearance which lies above the tolerance limits remains here. This increases the accuracy of the arrangement. The more interlocking projections and cutouts are present, the better the forces are distributed over the circumference of the ring gear and the housing part.

A substantially stronger mechanical connection can be achieved through the use of one fully circumferential or several—in particular, three, six, or more, distributed around the full circumference—radial extension(s). In principle, the more extensions or other contours are present and contribute to the positive-locking fit, the smaller they can be selected to be.

The heat-shrink tubing expediently envelops the extensions at least partially—ideally, completely or almost completely.

So that the heat-shrink tubing can fit as snugly as possible against the extensions and no damage to the heat-shrink occurs, the cross-sections of the extensions should not be sharp-edged. It is proposed to provide the extensions in their end region with a semicircular cross-section.

In another proposal, the extension has a similar cross-section, with an angular contour. In this case, four circumferentially oriented edges, for example, are provided.

The transferable axial force can be maximized by means of differently inclined side surfaces, wherein the surfaces facing away from each other mainly point in a direction parallel to the axis. The more inclined side surface increases the strength of the mechanical connection.

Axially overlapping regions between the ring gear and the housing part facilitate an exact radial assignment of the two components to be connected to one another.

An increased absorption of force in the axial direction can be ensured by using snap hooks and cutouts that are arranged in the overlapping region and are integral with the components to be joined. In this way, the largest part of the forces which arise is absorbed by the positive-locking contours, and the heat-shrink tubing must absorb only the reaction forces that act in the radial direction. For this purpose, the heat-shrink tubing lies in the ring gear and/or on the housing part in the overlapping regions and thereby secures the snap hooks against unlocking. When the heat-shrink tubing is sufficiently dimensioned, it can cover the snap hooks to such an extent that they are not externally discernible. Increased visual demands are thus also met.

The invention further comprises a geared motor with a mechanical connection between a ring gear, consisting of plastic, and a housing part, wherein the connection is positive-locking and/or frictional and is formed with the aid of heat-shrink tubing consisting of a plastic material. The aforementioned embodiments and variants are also applicable for this purpose.

### BRIEF DESCRIPTION OF THE SEVERAL VIEWS OF THE DRAWINGS

The exemplary embodiments of the invention are further explained below, with reference to the drawings. Shown are:

FIG. 1 is a schematic drawing of a first embodiment of a mechanical connection prior to a heat-shrinking process,

FIG. 2 is a schematic drawing of the first embodiment after the heat-shrinking process,

FIG. 3 is a schematic drawing of a second embodiment of a mechanical connection prior to a heat-shrinking process,

FIG. 4 is a schematic drawing of the second embodiment after the heat-shrinking process,

FIG. 5 is a schematic drawing of a third embodiment of a mechanical connection prior to a heat-shrinking process,

FIG. 6 is a schematic drawing of the third embodiment after the heat-shrinking process,

FIG. 7 is a plan view of a geared motor with a mechanical connection according to the third embodiment,

FIG. 8 is a schematic drawing of a fourth embodiment of a mechanical connection prior to a heat-shrinking process,

FIG. 9 is a schematic drawing of the fourth embodiment after the heat-shrinking process,

FIG. 10 is a plan view of a first variant of a ring-like extension,

FIG. 11 is a plan view of a second variant of a ring-like extension,

FIG. 12 is a plan view of a third variant of a ring-like extension,

FIG. 13 is a plan view of a first variant of a rotation lock, and

FIG. 14 is a plan view of a second variant of a rotation lock.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

FIG. 1 shows a first embodiment of a mechanical connection prior to a heat-shrinking process, with a ring gear 1a, a housing part 2a, and heat-shrink tubing 3a which is arranged around a connecting region 10a between the ring gear 1a and the housing part 2a. The connecting section is made of cylinder jacket surfaces having a rough surface. In this state, the diameter of the heat-shrink tubing is greater than the diameter of the connecting region 10a.

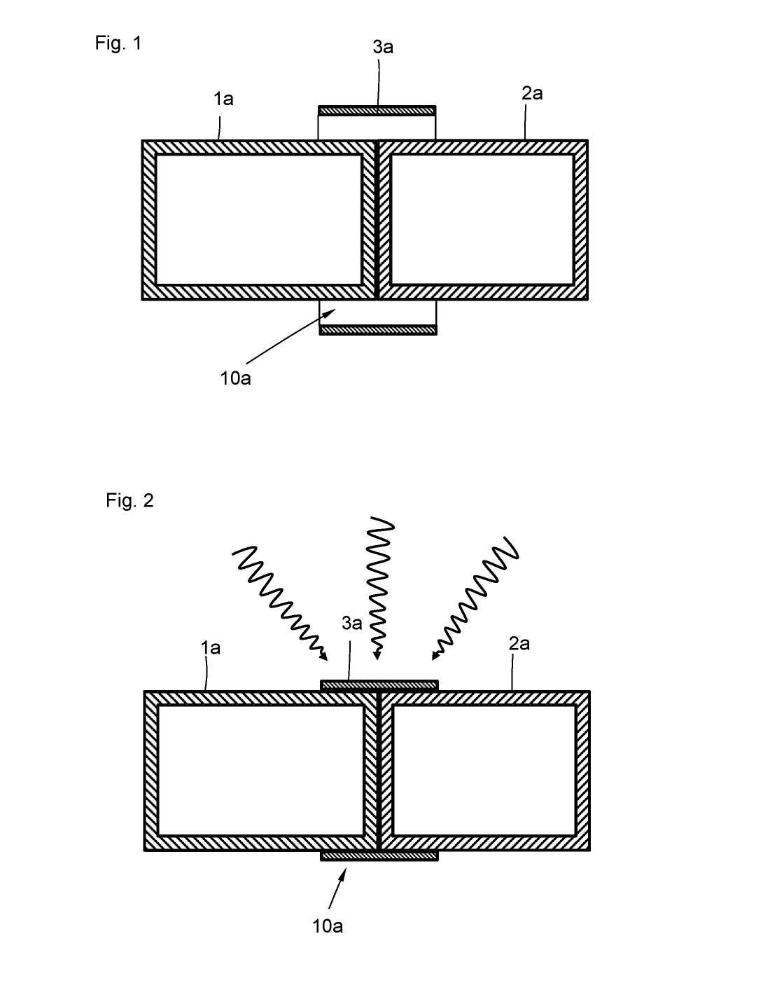

FIG. 2 shows the first embodiment after the heat-shrinking process, which was triggered by application of heat to the heat-shrink tubing 3a. The heat-shrink tubing 3a is firmly pressed against the cylinder jacket surfaces of the ring gear 1a and the housing part 2a. The contact pressure results from the tangentially-acting tension within the heat-shrink tubing and presses the heat-shrink tubing 3a radially against the ring gear la and the housing part 2a. The axial holding force is frictional.

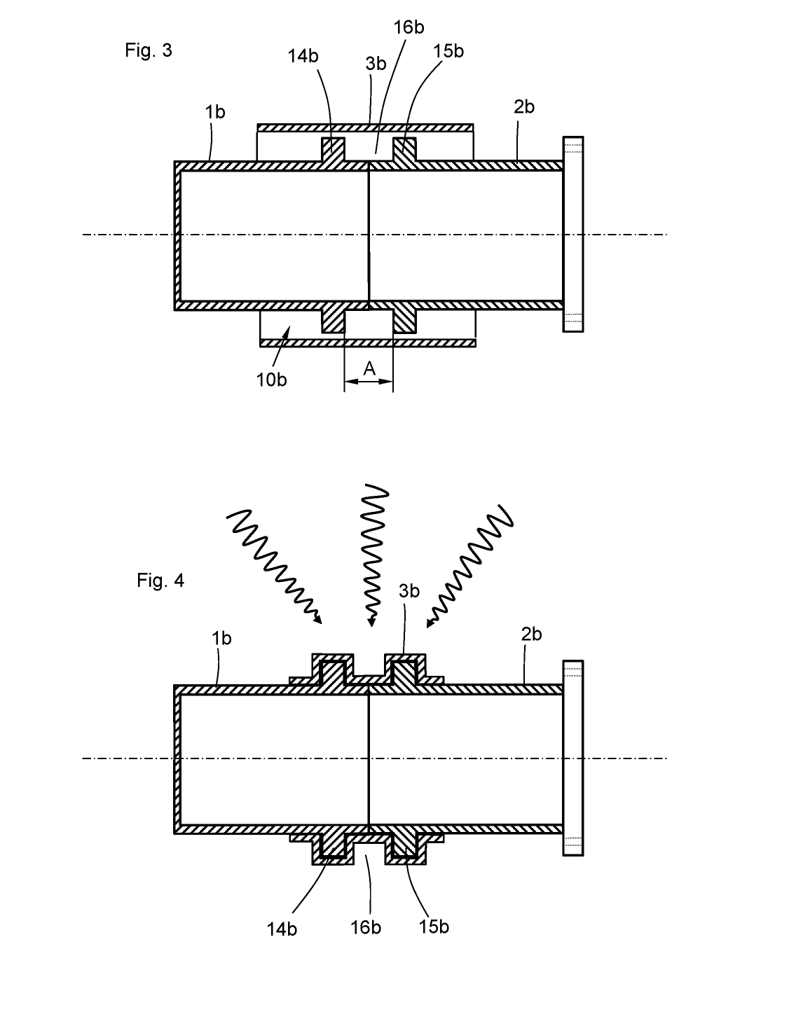

FIG. 3 shows a second embodiment of a mechanical connection prior to a heat-shrinking process, with a ring gear 1b, a housing part 2b, and heat-shrink tubing 3b arranged around a connecting region 10b between the ring gear 1b and the housing part 2b. The ring gear 1b has a first radial extension 14b, and the housing part 2b has a second radial extension 15b. Between the radial extensions 14b, 15b, there is a central region 16b which defines a distance A between the radial extensions 14b, 15b. The connecting region consists of several sections of cylinder jacket surfaces of different diameters. The cylinder jacket surfaces have a rough surface. In this state, the diameter of the heat-shrink tubing is greater than the diameter of the connecting region 10a, and greater than the radial extensions 14b, 15b.

FIG. 4 shows the second embodiment after the heat-shrinking process, which was triggered by the application of heat to the heat-shrink tubing 3b. The heat-shrink tubing 3b is pressed firmly against the cylinder jacket surfaces of the ring gear 1b and of the housing part 2b, as well as on the radial extensions 14b 15b. The heat-shrink tubing 3b is constricted, groove-like, in the middle region 16b and, in the axial direction, forms a positive-locking connection to the ring gear 1b, on the one hand, and the housing part 2b, on the other. The heat-shrink tubing 3b assumes a wave-like shape in the axial direction, but nevertheless connects the ring gear 1b and the housing part 2b in the circumferential direction in only a friction-locked manner.

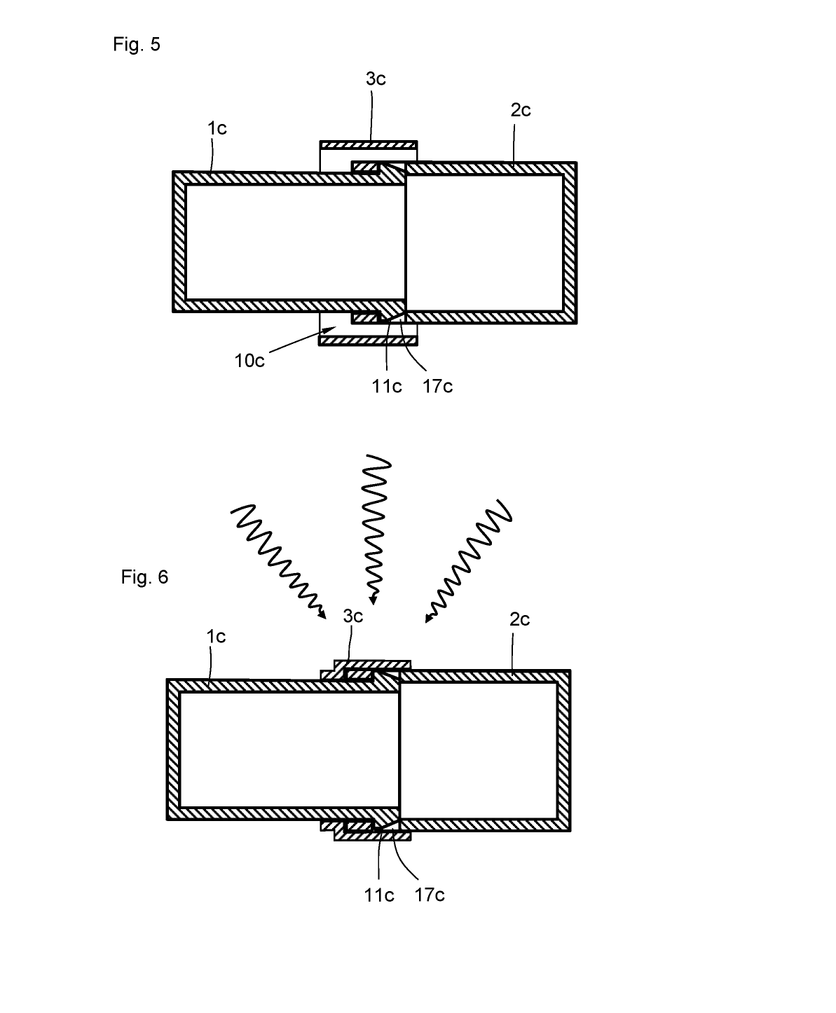

FIG. 5 shows a third embodiment of a mechanical connection prior to a heat-shrinking process, with a ring gear 1c, a housing part 2c, and heat-shrink tubing 3c. The housing part 2c has a larger diameter than the ring gear 1c. The housing part 2c and the ring gear 1c overlap in a connecting region 10c, and the ring gear 1c has snap hooks 11c that engage in the snap-in recesses 17c of the housing part 2c, which forms a snap connection. The snap connection is already a positive-locking fit, both in the axial and in the circumferential direction. Heat-shrink tubing is provided in order to secure the snap connection against loosening. In FIG. 5, the heat-shrink tubing is arranged around the connecting region 10c and has a larger diameter than the housing part 2c and the ring gear 1c. With the exception of the snap hooks 11c and the snap-in recesses 17c, the connecting region 10c consists of cylinder jacket surfaces.

FIG. 6 shows the third embodiment after the heat-shrinking process, which was triggered by the application of heat to the heat-shrink tubing 3c. The heat-shrink tubing 3c is firmly pressed against the cylinder jacket surfaces of the ring gear 1c and of the housing part 2c, and completely covers the snap hooks 11c and snap-in recesses 17c. In the direction of the housing part 2c, there is a positive-locking connection between the heat-shrink tubing 3c and the housing part 2c; in the opposite axial direction, there is only a friction-locked connection. There is basically only a friction-locked connection in the circumferential direction. The snap hooks 11c and snap-in recesses 17c may also have a positive-locking effect.

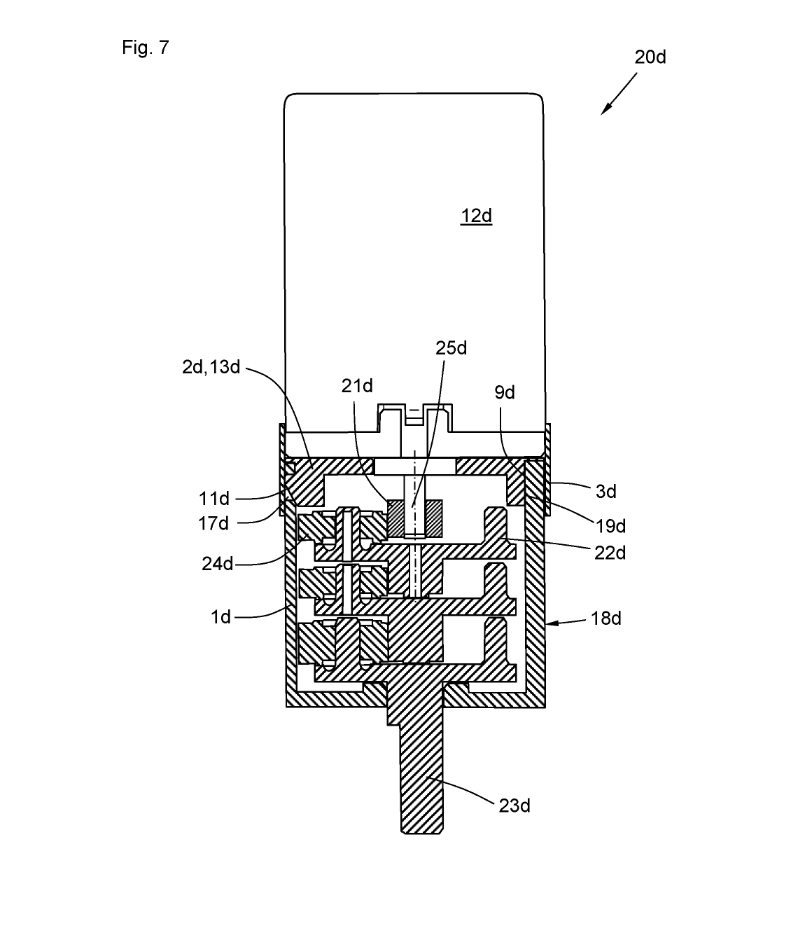

FIG. 7 shows a geared motor 20d, consisting of an electric motor 12d, a planetary gear 18d, and an adapter 13d, which is a housing part 2d that mechanically connects with a ring gear 1d of the planetary gear 18d. On the outer circumference of the adapter 13d, there are outer teeth 19d that engage in internal teeth 9d of the ring gear 1d and thereby already create an extensive positive-locking connection between the adapter 13d and the ring gear 1d in the circumferential direction. The outer teeth 19d of the adapter are, in three regions arranged 120° from one another, interrupted by snap-in tabs 11d which engage in snap-in recesses 17d of the ring gear 1d. The snap connection forms a positive-locking connection between the ring gear 1d and the housing part 2d in the axial direction as well. The snap connection is secured by heat-shrink tubing 3d, as in FIG. 6. The planetary gear consists of a first sun gear 21d, which is mounted on an engine shaft 25d, and several planetary carriers 22d which are each integral with another sun gear or with an output shaft 23d. Each planetary carrier 22d bears three planet gears 24d that engage with the inner teeth 9d of the ring gear 1d. The internal teeth 9d consist of a single, axially continuous toothing of a constant diameter.

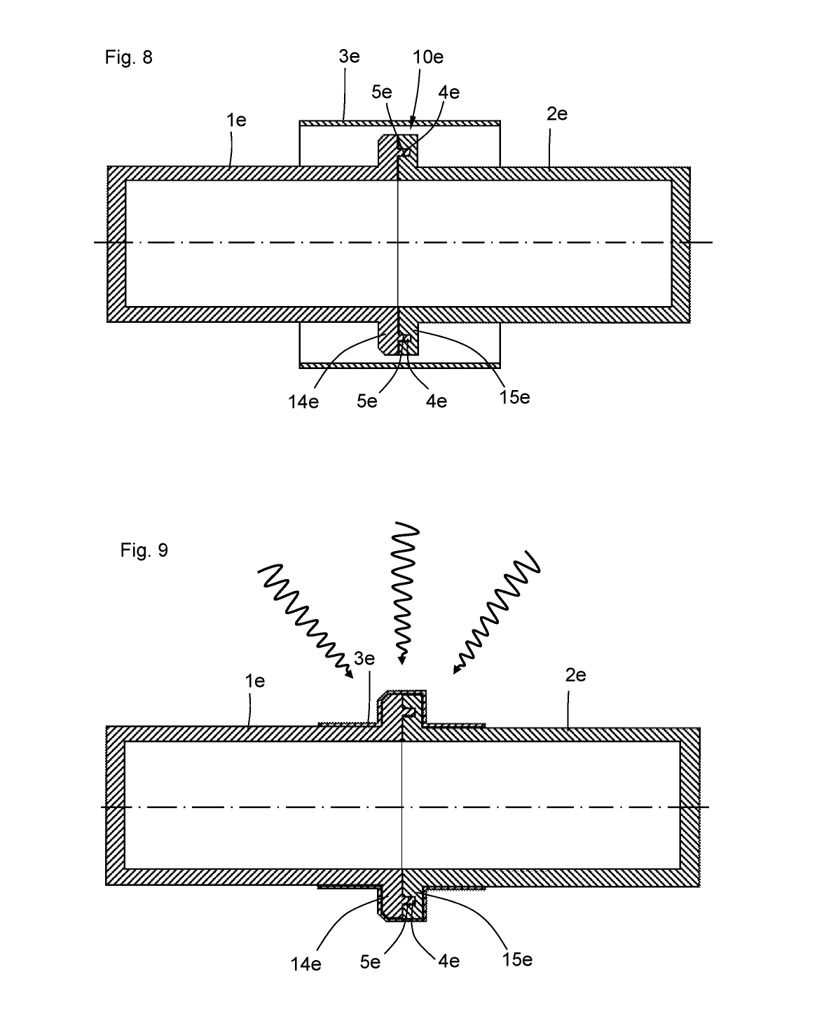

FIG. 8 shows a fourth embodiment of a mechanical connection prior to a heat-shrinking process, with a ring gear 1e, a housing part 2e, and heat-shrink tubing 3e. The ring gear 1e has a first ring-like extension 14e, and the housing part 2e has a second ring-like extension 15e. The two ring-like extensions 14e, 15e directly abut one another axially. Several projections 4e extend axially from the first ring-like extension 14e and engage in cutouts 5e of the second ring-like extension 15e. In an assembled state, the projections 4e and the cutouts 5e form a rotation lock between the ring gear 1e and the housing part 2e. The heat-shrink tubing 3e is located around a connecting region 10e which extends on either side of the ring-like extensions 14e and 15e and has cylindrical-jacket-like regions with different diameters.

FIG. 9 shows the fourth embodiment after the heat-shrinking process, which was triggered by the application of heat to the heat-shrink tubing 3e. The heat-shrink tubing 3e is firmly pressed against the cylinder jacket surfaces of the ring gear 1e and of the housing part 2e, as well as on the ring-like extensions 14e and 15e. In the axial direction, the heat-shrink tubing forms a positive-locking connection to the ring-like extensions 14e, 15b, and thus also to the ring gear 1e and the housing part 2e. In the circumferential direction, there is a friction-locked connection between the heat-shrink tubing 3e and the ring gear 1e, as well as the housing part 2e.

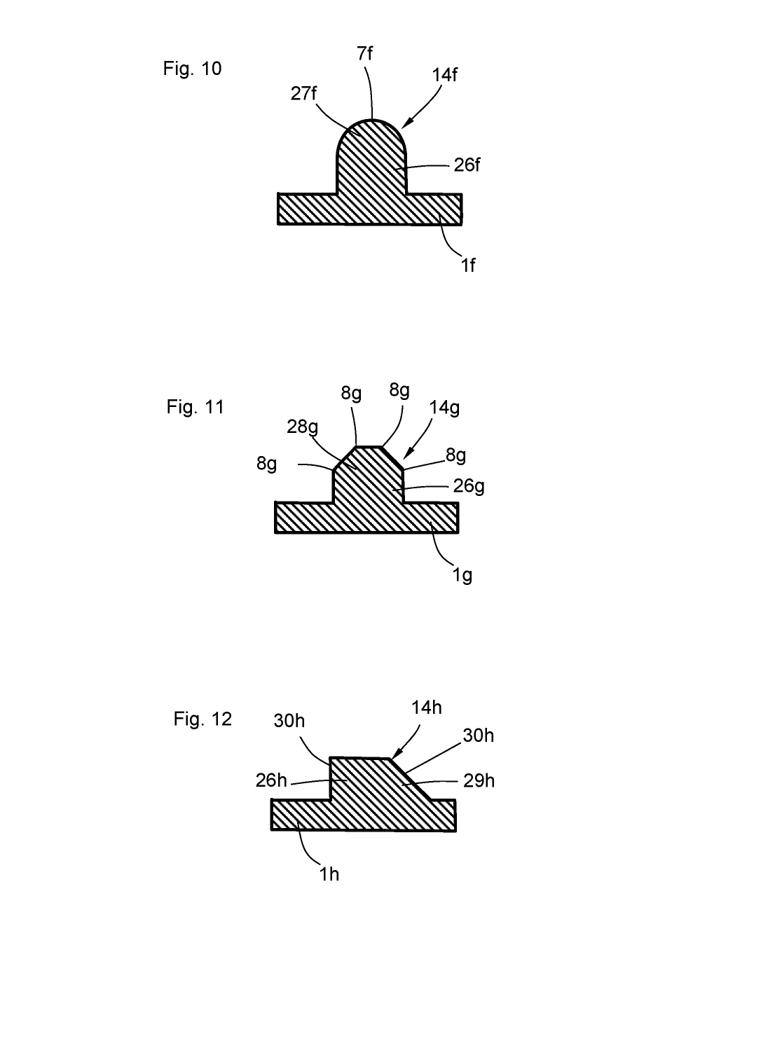

FIG. 10 shows a first variant of a ring-like extension 14f consisting of a rectangular ring region 26f and a semicircular ring-like region 27f The round contour 7f of the semicircular shape prevents damage to the heat-shrink tubing during shrinkage, since it has no sharp edges.

FIG. 11 shows a second variant of a ring-like extension 14g consisting of a rectangular ring region 26g and a trapezoidal ring region 28g. The trapezoidal shape reduces the risk of damage to the heat-shrink tubing, but also, by means of edges 8g, increases the transmittable holding force.

FIG. 12 shows a third variant of a ring-like extension 14h consisting of a rectangular ring region 26h and a triangular ring region 29h. The axial holding force in a first axial direction is thus higher than in a second axial direction.

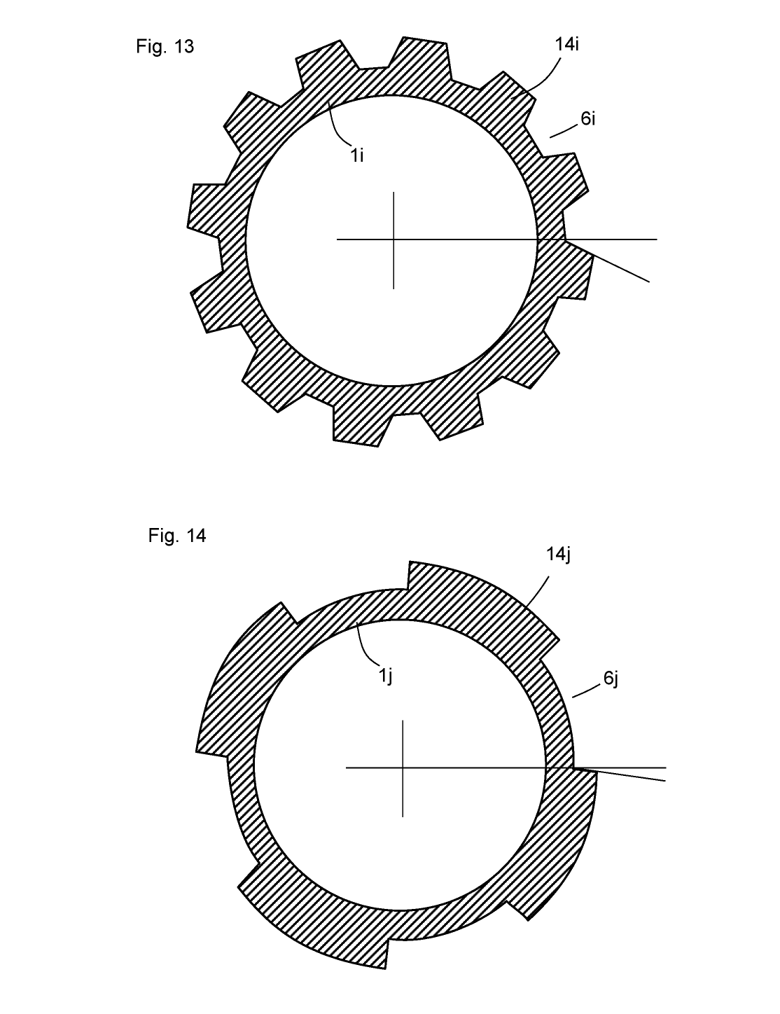

FIG. 13 shows a first variant of a rotation lock that can be produced between heat-shrink tubing (not shown here) and a ring-like extension 14i by the positive-locking shrinkage of the heat-shrink tubing. The ring-like extension 14i is interrupted by a plurality of recesses 6i. The achievable strength of the connection can be influenced by the number of recesses 6i and their depth. At a plurality of recesses, the heat-shrink tubing will not shrink completely into the recesses, which reduces the strength of the rotation lock. The recesses are also not exactly radial, but rather slightly inclined against the radial direction, so that the strength in the circumferential direction is also thus reduced.

FIG. 14 shows a second variant of a rotation lock that can be produced between heat-shrink tubing (not shown here) and a ring-like extension 14i by the positive-locking shrinkage of the heat-shrink tubing. The ring-like extension 14f is interrupted by four recesses 6j. Here, the heat-shrink tubing may exactly assume the shape of the recesses 6j. In addition, the flanks of the recesses 6j are approximately parallel to radials. Both of these measures can increase the strength of the connection in the circumferential direction.

By means of the variants according to FIGS. 13 and 14, additional rotation lock contours can be omitted, or an existing rotation lock can be enhanced and improved.

The second ring-like extensions 15 can be shaped to be analogous to the first ring-like extension 14f, 14g, 14h, 14i, 14j according to FIGS. 10 through 14.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS

1 Ring gear

2 Housing part

3 Heat-shrink tubing

4 Protrusion

5 Cutout

6 Recess

7 Edge/round contour

8 Edge

9 Internal teeth

10 Connecting region

11 Snap hook

12 Electric motor

13 Adapter

14 First extension

15 Second extension

16 Middle segment

17 Snap-in recess

18 Planetary gear unit

19 Outer teeth

20 Geared motor

21 Sun gear

22 Pinion cage

23 Output shaft

24 Planetary gear

25 Motor shaft

26 Rectangular ring region

27 Semi-circular ring region

28 Trapezoidal ring region

29 Triangular ring region

30 Side surface

What is claimed is:

1. A mechanical connection between a ring gear made of plastic, and a housing part, the mechanical connection comprising: a heat-shrunk tubing made of plastic, the heat-shrunk tubing positioned in a connecting region between the ring gear and the housing part to create a positive-locking and/or frictional connection between the ring gear and the housing part.

2. The mechanical connection according to claim 1, wherein the connection is positive-locking, and the positive-locking connection is formed only by the heat-shrink tubing.

3. The mechanical connection according to claim 1, wherein the connection is positive-locking, and the positive-locking connection is formed indirectly by the heat-shrink tubing.

4. The mechanical connection according to claim 1, further comprising a rotation lock for securing the ring gear against rotation with respect to the housing part in a positive-locking manner.

5. The mechanical connection according to claim 4, wherein the rotation lock is formed by interlocking teeth between the ring gear and the housing part.

6. The mechanical connection according to claim 4, wherein the rotation lock is formed by at least one axial projection of the ring gear which engages in corresponding cutouts of the housing part, or by at least one axial projection of the housing part which engages in corresponding cutouts of the ring gear.

7. The mechanical connection according to claim 1, wherein the ring gear and/or the housing part has at least one fully circumferential radial extension.

8. The mechanical connection according to claim 7, wherein the heat-shrink tubing at least partially envelops the extension or extensions.

9. The mechanical connection according to claim 6, wherein the rotation lock is arranged in or on the extension or extensions.

10. The mechanical connection according to claim 7, wherein the extension or extensions have a round contour in their end region.

11. The mechanical connection according to claim 7, wherein the entension or extensions have in their end region a plurality of edges arranged in the circumferential direction.

12. The mechanical connection according to claim 7, wherein the extension or extensions have differently inclined side surfaces, wherein the side surfaces facing away from each other mainly point in a direction parallel to the axis.

13. The mechanical connection according to claim 1, wherein the ring gear and the housing part have axially overlapping regions.

14. The mechanical connection according to claim 13, further comprising snap hooks provided on the ring gear and/or on the housing part, and cutouts or openings, which cooperate with the snap hooks, are provided on the joining partner housing part and/or ring gear.

15. The mechanical connection according to claim 14, wherein the heat-shrink tubing rests on the ring gear and/or on the housing part in the overlapping regions and thereby secures the snap hooks against unlocking.

16. A geared motor with a mechanical connection between a ring gear, made of plastic, and a housing part, wherein the connection is positive-locking and/or frictional and is formed with the aid of heat-shrink tubing consisting of a plastic material.

17. The mechanical connection according to claim 1, wherein the ring gear and/or the housing part has three radial extensions distributed around the full circumference.

18. The mechanical connection according to claim 1, wherein the ring gear and/or the housing part has six radial extensions distributed around the full circumference.
